(19) United States
(12) Patent Application Publication
(10) Pub. No.: US 2026/0269943 A1
(43) Pub. Date: Sep. 10, 2026

(54) OPTICAL DISTRIBUTION NETWORK WITH COEXISTING PASSIVE OPTICAL NETWORK AND COHERENT PASSIVE OPTICAL NETWORK

(71) Applicant: CABLE TELEVISION LABORATORIES, INC., Louisville, CO (US)

(72) Inventors: Haipeng Zhang, Broomfield, CO (US); Zhensheng Jia, Superior, CO (US)

(21) Appl. No.: 19/558,189

(22) Filed: Mar. 5, 2026

Related U.S. Application Data
(60) Provisional application No. 63/768,413, filed on Mar. 7, 2025.

(51) Int. Cl. H04B 10/272; H04B 10/50; H04B 10/54; H04B 10/61; H04J 14/02

(52) U.S. Cl. CPC H04B 10/272; H04B 10/505; H04B 10/54; H04B 10/61; H04J 14/0282; H04J 14/0307

(57) ABSTRACT

An optical distribution network with coexisting passive optical network (PON) and a coherent passive optical network (CPON) and method of use are provided. The PON includes a PON optical line terminal (OLT) configured to transmit a PON downstream optical signal to a PON optical network unit (ONU) disposed remotely from the PON OLT and to receive a PON upstream optical signal from the PON ONU. The CPON includes a CPON OLT configured to transmit a CPON downstream optical signal at a CPON downstream coherent wavelength to a CPON ONU disposed remotely from the CPON OLT and to receive a CPON upstream optical signal from the CPON ONU. The CPON ONU includes a tunable coherent receiver configured to receive the CPON downstream optical signal at the CPON downstream coherent wavelength.

### CROSS REFERENCE TO RELATED APPLICATIONS

This application claims the benefit of U.S. Provisional Application No. 63/768,413, filed on March 7, 2025, which application is incorporated herein by reference in its entirety.

### BACKGROUND

The field of the disclosure relates generally to communication networks, and more particularly, to an optical distribution network (ODN) with a coexisting passive optical network (PON) and a coherent passive optical network (CPON).

Conventional passive optical networks (PONs) are known to use point-to-multipoint (P2MP) architectures that are implemented extensively worldwide, and which have become a primary vehicle to meet the growing capacity demands in optical access networks. PON technology and architectures are expected to grow significantly in the near future, due to such factors as: (a) increasing demand for high-speed internet, (b) need for more efficient and reliable network infrastructures, and (c) increasing adoption of fiber-to-the-home (FTTH) and fiber-to-the-premises (FTTP) technologies that rely on PONs to deliver high-speed internet access to homes and businesses. Additionally, driven by the desire for minimal latency, decreased jitter, and enhanced quality of experience (QoE) in virtual reality (VR) games and cloud-based applications, there is a desire in the optical communication field to continue to grow and improve fiber access technologies.

Conventional PONs, however, have focused primarily on intensity modulation direct detection (IM-DD) technology, which has been unable to meet the needs for the emerging 100G PON standard, due to such known IM-DD limitations such as insufficient power budgets, bandwidth limitations, and transmission impairments such as chromatic dispersion (CD). Nevertheless, there is a significant desire in the industry to move even further towards next generation (NG) PONs operating up to speeds of 100 Gb/s (100G) and greater. However, conventional IM-DD technologies are lacking in cost-effective solutions to meet such growth needs.

Recent solutions based on coherent PON (CPON) technology though, have offered solutions to meeting these new high-speed demands, due to the heightened sensitivity, advanced modulation, and robust digital signal processing (DSP) exhibited by CPON, in comparison to IM-DD PONS. Various CPON technologies have been developed over time, including time-division-multiplexing (TDM) PONs, wavelength-division-multiplexing (WDM) PONs, and time-and-frequency-division multiplexing (TFDM) PONs.

One critical requirement from network operators for the future evolution of CPON systems is the ability to stack multiple coherent wavelengths within the same ODN utilizing an existing PON system. Such wavelength stacking is essential for scaling network capacity while ensuring efficient use of the available spectrum and the corresponding fiber infrastructure. Additionally, the coexistence of these advanced CPON wavelengths with legacy IM-DD PON systems is crucial to maintain service continuity and protect existing infrastructure investments during the transition to next-generation networks. Thus, there is a desire in the industry to improve upon existing ODNs to enable coexistence of advanced CPON wavelengths with legacy PON systems.

### SUMMARY

The techniques of this disclosure generally relate to an optical distribution network (ODN) with a coexisting passive optical network (PON) and coherent passive optical network (CPON). The ODN provides for the stacking of multiple CPON wavelengths alongside legacy PON systems using intensity modulation direct detection (IM-DD) and/or wavelengh-division-multiplexing (WDM). More specifically, tunable coherent receivers such as, for example, colorless coherent receivers enable wavelength selection at an end user, thereby enabling multiple CPON signals at different wavelengths to be bidirectionally transmitted (e.g., upstream or downstream) alongside a conventional PON signal in the same ODN.

Example aspects of the present disclosure according to at least one embodiment of the present disclosure comprises:

An optical distribution network comprising: a passive optical network (PON) optical line terminal (OLT) configured to transmit a PON downstream optical signal to a PON optical network unit (ONU) disposed remotely from the PON OLT and to receive a PON upstream optical signal from the PON ONU; a coherent passive optical network (CPON) OLT configured to transmit a CPON downstream optical signal to a CPON ONU disposed remotely from the CPON OLT and to receive a CPON upstream optical signal from the CPON ONU; an optical communication medium in operable communication with the PON OLT and the CPON OLT, and configured to transport the PON downstream optical signal to the PON ONU and the PON upstream optical signal to the PON OLT, and to transport the CPON downstream optical signal to the CPON ONU and the CPON upstream optical signal to the CPON OLT; the PON ONU in operable communication with the optical communication medium and including an optical receiver configured to receive the PON downstream optical signal and a PON optical transmitter configured to transmit the PON upstream optical signal; and the CPON ONU in operable communication with the optical communication medium and including a tunable coherent receiver configured to receive the CPON downstream optical signal and a CPON optical transmitter configured to transmit the CPON upstream optical signal.

Any of the aspects herein, wherein the CPON OLT comprises a plurality of CPON OLTs and each CPON OLT is configured to transmit a corresponding CPON downstream optical signal of a plurality of CPON downstream optical signals and to receive a corresponding CPON upstream optical signal of a plurality of CPON upstream optical signals, each CPON downstream optical signal transmitted at a corresponding downstream coherent wavelength and each CPON upstream optical signal transmitted at a corresponding upstream coherent wavelength, and wherein the CPON ONU comprises a plurality of corresponding CPON ONUs and each tunable coherent receiver is tuned to the first corresponding coherent wavelength, and wherein each CPON OLT is tuned to the second corresponding coherent wavelength.

Any of the aspects herein, wherein a first downstream coherent wavelength of a first CPON downstream optical signal is different than a second downstream coherent wavelength of a second CPON downstream optical signal, and wherein a first upstream coherent wavelength of a first CPON upstream optical signal is different than a second upstream coherent wavelength of a second CPON upstream optical signal.

Any of the aspects herein, further comprising: a multiplexer configured to multiplex the plurality of CPON downstream optical signals to yield a combined CPON downstream optical signal and to demultiplex a combined CPON upstream optical signal into the plurality of CPON upstream optical signals.

Any of the aspects herein, wherein the PON OLT and PON ONU use at least one of intensity modulation with direct detection (IM-DD), wavelength-division-multiplexing (WDM), or a combination of IM-DD and WDM.

Any of the aspects herein, further comprising: a coexistence element (CEx) in communication with the PON OLT and the CPON OLT, the CEx configured to combine the PON downstream optical signal and the combined CPON downstream optical signal into a combined downstream signal for transmission through the optical communication medium, the CEx configured to also split a combined upstream signal into the PON upstream optical signal and the combined CPON upstream optical signal; and at least one splitter in communication with the CEx, the PON ONU, and the CPON ONU, the at least one splitter configured to split the combined signal into a plurality of split signals for transmission to the PON ONU and the CPON ONU.

Any of the aspects herein, wherein the plurality of split signals are equal signals.

Any of the aspects herein, further comprising: an optical filter in communication with the splitter, the PON ONU, and the optical communication medium, the optical filter configured to filter a target wavelength from a split signal of the plurality of split signals received from the splitter to yield a filtered split signal.

Any of the aspects herein, wherein the tunable coherent receiver comprises a colorless coherent optical receiver that comprises a local oscillator and digital signal processing (DSP), and wherein the local oscillator and the DSP are tuned to select a target wavelength from a split signal of the plurality of split signals received from the splitter.

Any of the aspects herein, wherein the tunable coherent receiver comprises a colorless coherent optical receiver.

A method according to at least one embodiment of the present disclosure comprises transmitting a plurality of CPON downstream optical signals via an optical communication medium, each CPON downstream optical signal generated by a CPON OLT of a plurality of CPON OLTs, each CPON downstream optical signal transmitted at a corresponding downstream coherent wavelength; multiplexing, by a multiplexer (MUX), the plurality of CPON downstream optical signals to yield a multiplexed CPON downstream optical signal; transmitting, by a PON OLT, a PON downstream optical signal via the optical communication medium, the PON downstream optical signal generated by the PON OLT; combining, by a coexistence element (CEx), the PON downstream optical signal and the multiplexed CPON downstream optical signal to yield a combined signal; splitting, by at least one splitter, the combined signal into a plurality of split signals; receiving, by a tunable downstream coherent receiver, a split signal of the plurality of split signals, the tunable downstream coherent receiver part of a CPON ONU of a plurality of CPON ONUs and tuned to the corresponding downstream coherent wavelength; and receiving, by an optical receiver, a split signal of the plurality of split signals, the optical receiver part of a PON ONU.

Any of the aspects herein, further comprising: transmitting a plurality of CPON upstream optical signals via the optical communication medium, each CPON upstream optical signal generated by a corresponding CPON ONU of the plurality of CPON ONUs and transmitted at a corresponding upstream coherent wavelength; transmitting, by the PON ONU, a PON upstream optical signal via the optical communication medium; combining, by the at least one splitter, the plurality of CPON upstream optical signals and the PON upstream optical signal into an upstream combined signal; splitting, by the CEx, the combined signal into a combined CPON upstream optical signal and the PON upstream optical signal; receiving, by the PON OLT, the PON upstream optical signal; demultiplexing, by the MUX, the combined CPON upstream optical signal to yield the plurality of upstream optical signals; and receiving the plurality of upstream optical signals by the plurality of CPON OLTs, each CPON OLT having a tunable upstream coherent receiver tuned to the corresponding upstream coherent wavelength.

Any of the aspects herein, wherein a first downstream coherent wavelength of a first CPON downstream optical signal is different than a second downstream coherent wavelength of a second CPON downstream optical signal, and wherein a first upstream coherent wavelength of a first CPON upstream optical signal is different than a second upstream coherent wavelength of a second CPON upstream optical signal.

Any of the aspects herein, wherein the PON OLT and PON ONU use at least one of intensity modulation with direct detection (IM-DD), wavelength-division-multiplexing (WDM), or a combination of IM-DD and WDM.

Any of the aspects herein, further comprising: filtering, by an optical filter, a target wavelength from a split signal of the plurality of split signals to yield a filtered split signal, the optical filter in communication with the at least one splitter, the PON ONU, and the optical communication medium.

Any of the aspects herein, wherein the tunable coherent receiver comprises a colorless coherent optical receiver that comprises a local oscillator and digital signal processing (DSP), and wherein the local oscillator and the DSP are tuned to select a target wavelength from a split signal of the plurality of split signals received from the splitter.

An optical distribution network according to at least one embodiment of the present disclosure comprises a passive optical network (PON) optical line terminal (OLT) configured to transmit a PON downstream optical signal to a PON optical network unit (ONU) disposed remotely from the PON OLT and to receive a PON upstream optical signal from the PON ONU; a plurality of coherent passive optical network (CPON) OLTs, each CPON OLT configured to transmit a CPON downstream optical signal of a plurality of CPON downstream optical signals to a corresponding CPON ONU of a plurality of CPON ONUs disposed remotely from the plurality of CPON OLTs and to receive a CPON upstream optical signal of a plurality of CPON upstream optical signals from a corresponding CPON ONU, each CPON downstream optical signal transmitted at a corresponding downstream coherent wavelength and each CPON upstream optical signal transmitted at a corresponding upstream coherent wavelength; a multiplexer configured to multiplex the plurality of CPON downstream optical signals to yield a combined CPON downstream optical signal and to demultiplex a combined CPON upstream optical signal into a plurality of CPON upstream optical signals; a coexistence element (CEx) in communication with the PON OLT and the multiplexer, the CEx configured to combine the PON downstream optical signal and the combined CPON downstream optical signal into a combined downstream signal and to separate a combined upstream signal into the combined CPON upstream optical signal and the PON upstream signal; at least one splitter in communication with the CEx, the PON ONU, the CPON ONU, the splitter configured to split the combined downstream signal into a plurality of split signals for transmission to the PON ONU and the plurality of CPON ONUs and to combine the PON upstream optical signal and the plurality of upstream optical signals into a combined upstream signal; and an optical communication medium in operable communication with the PON, the plurality of CPONs, the PON ONU, the plurality of CPON ONUs, the CEx, and the splitter, the optical communication medium configured to transport the PON downstream optical signal to the PON ONU and the PON upstream optical signal to the PON OLT, and to transport the plurality of CPON downstream optical signals to the plurality of CPON ONUs and the plurality of CPON upstream optical signals to the plurality of CPON OLTs, the PON ONU in operable communication with the optical communication medium and the splitter, the PON ONU including an optical receiver configured to receive a split signal of the plurality of split signals and a PON optical transmitter configured to transmit the PON upstream optical signal; and each CPON ONU of the plurality of CPON ONUs in operable communication with the optical communication medium and the splitter, each CPON ONU including a tunable coherent receiver configured to receive a split signal of the plurality of split signals and a CPON optical transmitter configured to transmit a corresponding CPON upstream optical signal, the tunable coherent receiver tuned to the corresponding coherent wavelength.

Any of the aspects herein, further comprising: an optical filter in communication with the at least one splitter, the PON ONU, and the optical communication medium, the optical filter configured to filter a target wavelength from the split signal of the plurality of split signals received from the splitter to yield a filtered split signal.

Any of the aspects herein, wherein the tunable coherent receiver comprises a colorless coherent optical receiver that comprises a local oscillator and digital signal processing (DSP), and wherein the local oscillator and the DSP are tuned to select a target wavelength from the split signal of the plurality of split signals received from the splitter.

Any of the aspects herein, wherein the PON uses at least one of intensity modulation with direct detection (IM-DD), wavelength-division-multiplexing (WDM), or a combination of IM-DD and WDM.

The details of one or more aspects of the disclosure are set forth in the accompanying drawings and the description below. Other features, objects, and advantages of the techniques described in this disclosure will be apparent from the description and drawings, and from the claims.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided herein below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed description of the various aspects, embodiments, and configurations of the disclosure, as illustrated by the drawings referenced below.

FIG. 1 is a schematic illustration of an optical distribution network according to at least one embodiment of the present disclosure.

FIG. 2A is a schematic illustration of a CPON optical network unit (ONU) according to at least one embodiment of the present disclosure.

FIG. 2B is a schematic illustration of CPON wavelengths according to at least one embodiment of the present disclosure.

FIG. 2C is a schematic illustration of a CPON wavelength according to at least one embodiment of the present disclosure.

FIG. 3A is a flowchart according to at least one embodiment of the present disclosure.

FIG. 3B is a flowchart according to at least one embodiment of the present disclosure.

FIG. 4A is a schematic illustration of an example test architecture for verifying experimental results implementing an optical distribution network according to at least one embodiment of the present disclosure.

FIG. 4B is a graphical illustration depicting a plot obtained using the test architecture depicted in FIG. 4A according to at least one embodiment of the present disclosure.

FIG. 4C is a graphical illustration depicting a plot obtained using the test architecture depicted in FIG. 4A according to at least one embodiment of the present disclosure.

FIG. 4D is a graphical illustration depicting a plot obtained using the test architecture depicted in FIG. 4A according to at least one embodiment of the present disclosure.

FIG. 4E is a graphical illustration depicting a plot obtained using the test architecture depicted in FIG. 4A according to at least one embodiment of the present disclosure.

FIG. 4F is a graphical illustration depicting a plot obtained using the test architecture depicted in FIG. 4A according to at least one embodiment of the present disclosure.

FIG. 5A is a schematic illustration of an example test architecture for verifying experimental results implementing an optical distribution network according to at least one embodiment of the present disclosure.

FIG. 5B is a graphical illustration depicting a plot obtained using the test architecture depicted in FIG. 5A according to at least one embodiment of the present disclosure.

FIG. 5C is a graphical illustration depicting a plot obtained using the test architecture depicted in FIG. 5A according to at least one embodiment of the present disclosure.

FIG. 5D is a graphical illustration depicting a plot obtained using the test architecture depicted in FIG. 5A according to at least one embodiment of the present disclosure.

FIG. 5E is a graphical illustration depicting a plot obtained using the test architecture depicted in FIG. 5A according to at least one embodiment of the present disclosure.

FIG. 5F is a graphical illustration depicting a plot obtained using the test architecture depicted in FIG. 5A according to at least one embodiment of the present disclosure.

FIG. 5G is a graphical illustration depicting a plot obtained using the test architecture depicted in FIG. 5A according to at least one embodiment of the present disclosure.

FIG. 5H is a graphical illustration depicting a plot obtained using the test architecture depicted in FIG. 5A according to at least one embodiment of the present disclosure.

FIG. 5I is a graphical illustration depicting a plot obtained using the test architecture depicted in FIG. 5A according to at least one embodiment of the present disclosure. and

FIG. 5J is a graphical illustration depicting a plot obtained using the test architecture depicted in FIG. 5A according to at least one embodiment of the present disclosure.

### DETAILED DESCRIPTION

### I. Definitions

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (i.e., X₁ and X₂), as well as a combination of elements selected from two or more classes (i.e., Y₁ and Zₒ).

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, i.e., “processing device,” “computing device,” and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc – read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (i.e., a processor) to process the data, and the time of a system response to the events and the environment. In the embodiments described herein, these activities and events occur substantially instantaneously.

As used herein, “modem termination system” (MTS) refers to a termination unit including one or more of an Optical Network Terminal (ONT), an optical line termination (OLT), a network termination unit, a satellite termination unit, a cable modem termination system (CMTS), and/or other termination systems which may be individually or collectively referred to as an MTS.

As used herein, “modem” refers to a modem device, including one or more of a cable modem (CM), a satellite modem, an optical network unit (ONU), a DSL unit, etc., which may be individually or collectively referred to as modems.

As used herein, the term “coherent transceiver,” unless specified otherwise, refers to a P2P or P2MP coherent optics transceiver having a coherent optics transmitting portion and a coherent optics receiving portion. In some instances, the transceiver may refer to a specific device under test (DUT) for several of the embodiments described herein.

As described herein, a “PON” generally refers to a passive optical network or system having components labeled according to known naming conventions of similar elements that are used in conventional PON systems. For example, an OLT may be implemented at an aggregation point, such as a headend/hub, and multiple ONUs may be disposed and operable at a plurality of end users, customer premises, or subscriber locations. Accordingly, an “uplink transmission” refers to an upstream transmission from an end user to a headend/hub, and a “downlink transmission” refers to a downstream transmission from a headend/hub to the end user, which may be presumed to be generally broadcasting continuously (unless in a power saving mode, or the like).

As used herein, “CPON” generally refers to a coherent passive optical network or system that uses coherent optical transmission techniques over a single fiber. Exemplary CPON architectures, as well as the respective components thereof, are described in greater detail in U.S. Patent No. 9,912,409, U.S. Patent No. 10,200,123, and U.S. Patent No. 10,523,356. Exemplary systems and methods for coherent burst reception are described in greater detail in U.S. Patent No. 11,575,448 and U.S. Patent No. 11,540,032. An exemplary rate-flexible CPON is described in co-pending U.S. Patent Application Serial No. 18/905,880, filed October 3, 2024. The disclosures of all of these prior patents and patent applications are incorporated by reference herein in their entireties.

The person of ordinary skill in the art will understand that the term “wireless,” as used herein in the context of optical transmission and communications, including free space optics (FSO), generally refers to the absence of a substantially physical transport medium, such as a wired transport, a coaxial cable, or an optical fiber or fiber optic cable.

As used herein, the term “data center” generally refers to a facility or dedicated physical location used for housing electronic equipment and/or computer systems and associated components, i.e., for communications, data storage, etc. A data center may include numerous redundant or backup components within the infrastructure thereof to provide power, communication, control, and/or security to the multiple components and/or subsystems contained therein. A physical data center may be located within a single housing facility or may be distributed among a plurality of co-located or interconnected facilities. A “virtual data center” is a non-tangible abstraction of a physical data center in a software-defined environment, such as software-defined networking (SDN) or software-defined storage (SDS), typically operated using at least one physical server utilizing a hypervisor. A data center may include thousands of physical servers connected by a high-speed network.

As used herein, the term “hyperscale” refers to a computing environment or infrastructure including multiple computing nodes and having the capability to scale appropriately as increased demand is added to the system, i.e., seamlessly provision infrastructure components and/or add computational, networking, and storage resources to a given node or set of nodes. A hyperscale system, or “hyperscaler” may include hundreds of data centers or more and may include distributed storage systems. A hyperscale system may utilize redundancy-based protection and/or erasure coding and may be typically configured to increase background load proportional to an increase in cluster size. A hyperscale node may be a physical node or a virtual node, and multiple virtual nodes may be located on the same physical host. Hyperscale management may be hierarchical, and a “distance” between nodes may be physical or perceptual. A hyperscale datacenter may include several performance optimized datacenters (PODs), and each POD may include multiple racks and hundreds and thousands of computer and/or storage devices.

### II. ODN with Coexisting PON and CPON systems

As described above, the disclosure generally relates to an ODN in which a PON and a CPON coexist. The ODN described herein provides for the stacking of multiple CPON wavelengths (as generated by CPON OLTs) alongside legacy PON systems using IM-DD and/or WDM. Such wavelength stacking is enabled by using tunable coherent receivers such as, for example, colorless coherent receivers that provide for wavelength selection at corresponding CPON ONUs.

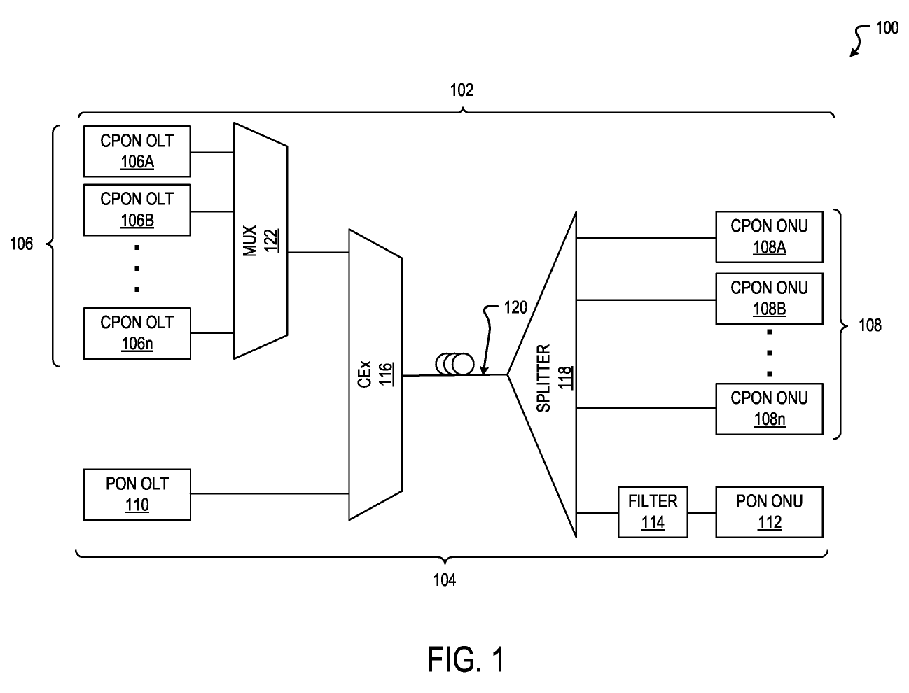

Turning to FIG. 1, a schematic illustration depicting an example ODN (100) is provided. In the illustrated embodiment, the ODN (100) includes a CPON (102) in coexistence with a PON (104) such that data can be transmitted via the CPON (102) and the PON (104) within the same ODN (100).

Generally, the CPON (102) includes one or more CPON OLTs (106) configured to transmit downstream CPON signals, via a CPON OLT transmitter, to one or more corresponding CPON ONUs (108) and to receive upstream CPON signals from the corresponding CPON ONUs (108), via a CPON OLT receiver. The CPON OLTs (106) can include one CPON OLT, two CPON OLTs, or more than two CPON OLTs. For example, the illustrated embodiment includes two CPON OLTs (106A), (106B), but can include n-number of CPON OLTs (106n). Similarly, the CPON ONUs (108) can include one CPON ONU, two CPON ONUs, or more than two CPON ONUs. For example, the illustrated embodiment includes two CPON ONUs (108A), (108B), and in other embodiments the CPON (102) can include n-number of CPON ONUs (108n).

In embodiments where the CPON OLT (106) and the CPON ONU (108) include more than one CPON OLT (106) and more than one CPON ONU (108), each CPON OLT (106) is configured to transmit a CPON downstream optical signal at a corresponding downstream coherent wavelength and each CPON ONU (108) is configured to receive the CPON downstream optical signal at the corresponding downstream coherent wavelength. Conversely, each CPON ONU (108) is configured to transmit a CPON upstream optical signal at a corresponding upstream coherent wavelength and a corresponding CPON OLT (106) is configured to receive the CPON upstream optical signal at the corresponding upstream coherent wavelength.

In such embodiments, the corresponding downstream or upstream coherent wavelengths for multiple CPON OLTs (106) and CPON ONUs (108) can be different downstream or upstream coherent wavelengths and the different coherent wavelengths can be stacked. For example, a first CPON OLT (106A) may transmit a first CPON downstream optical signal at a first downstream coherent wavelength and a second CPON OLT (106B) may transmit a second CPON downstream optical signal at a second downstream coherent wavelength. The first downstream wavelength and the second downstream wavelength may be different and adjacent wavelengths.

The PON (104) includes a PON OLT (110) configured to transmit a PON downstream optical signal, via a PON OLT transmitter, to a PON ONU (112) and to receive a PON upstream optical signal, via a PON OLT receiver. The PON (104) also includes a filter (114) configured to filter a target wavelength from the PON downstream optical signal. The filter (114) can be, for example, an optical colored filter.

In at least one embodiment, the CPON OLT (106) and/or the PON OLT (110) may be located within a central office, a communications hub, or a headend of an optical link, and functions to convert standard signals from a service provider (not shown) to the various frequencies, modulation formats, baud rates, and framings used by the ODN (100).

Further, the CPON OLTs (106) and/or the PON OLT (110) are in communication with the CPON ONUs (108) and the PON ONU (112), respectively, via an optical communication medium (120). In at least one embodiment, the optical communication medium (120) may include a single mode fiber (SMF) or a multimode fiber (MMF).

The ODN (100) also includes a multiplexer (MUX) (122). The MUX (122) is configured to multiplex multiple CPON downstream optical signals to yield a combined or multiplexed CPON downstream optical signal. More specifically, the MUX (122) combines multiple wavelengths (e.g., coherent wavelengths of the multiple CPON downstream optical signals) for propagation in the optical communication medium (120). The MUX (122) is positioned between and is in communication with the CPON OLTs (106) and a coexistence element (CEx) (116). The MUX (122) is also configured to demultiplex a combined CPON upstream optical signal (received from, for example, the CEx (116)) into a plurality of CPON upstream optical signals.

The ODN (100) also includes the CEx (116). The CEx (116) is configured to combine a PON downstream optical signal (from the PON OLT (110)) and the combined CPON downstream optical signal (from the MUX (122)) into a combined downstream signal for transmission through the optical communication medium (120). The CEx (116) is also configured to split a combined upstream signal (received from, for example, the splitter (118)) into the PON upstream optical signal and the combined CPON upstream optical signal. The CEx (116) can be, for example, a single wavelength division multiplexing (WDM) device. As shown, the CEx (116) is positioned after the MUX (122) and the PON OLT (110) and prior to the splitter (118).

The ODN (100) also includes the splitter (118). The splitter (118) can be a passive, optical splitter configured to split a single signal into multiple signals. In some embodiments, the splitter (118) can be a cascade splitter. In alternative embodiments, the ODN (100) can include multiple splitters (118). For example, the ODN (100) can include another splitter positioned between the splitter (118) and the CPON ONUs (108). In the illustrated embodiment, the splitter (118) is positioned between the CEx (116) and both the CPON ONUs (108) and the filter (114).

The splitter (118) is configured to split the combined downstream signal from the CEx (116) into multiple, equal split signals that are received by the CPON ONUs (108) and the filter (114). The splitter (118) is also configured to combine a PON upstream optical signal and CPON upstream optical signal(s) into a combined upstream signal from the PON ONU (112) and the CPON ONUs (108).

Though not shown, the ODN (100) can include a demultiplexer (DMUX) to separate the combined downstream optical signal into different wavelength channels. In embodiments where the ODN (100) includes the DMUX, the DMUX can be positioned between the CEx (116) and the splitter (118) such that the combined signal is initially separated into different wavelength channels prior to the splitter (118).

It will be appreciated that the ODN (100) can include more or less components than shown and described.

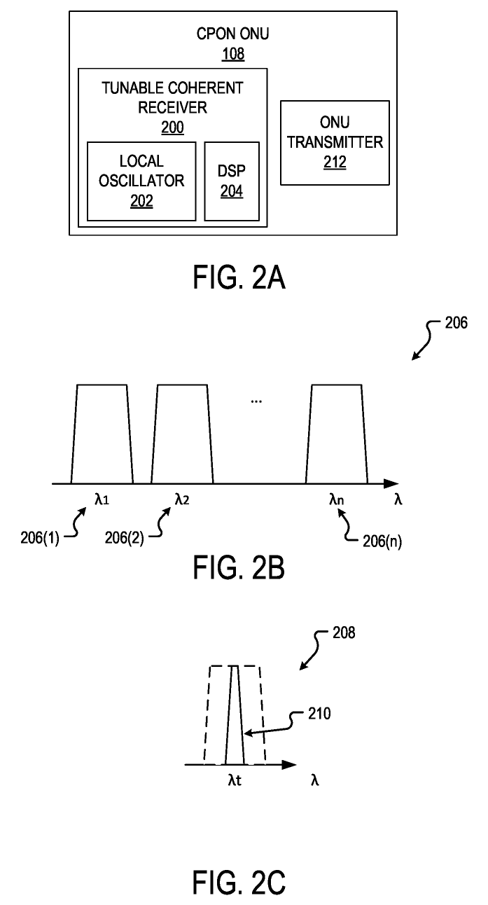

Turning to FIGS. 2A-2C, a schematic illustration of a CPON ONU (108), a schematic illustration of CPON wavelengths, and a schematic illustration of a target CPON wavelength are respectively shown. As shown in FIG. 2A, the CPON ONU (108) includes an ONU transmitter (212). The ONU transmitter (212) is tunable and is configured to transmit a CPON upstream optical signal at a corresponding upstream coherent wavelength.

The CPON ONU (108) also includes a tunable coherent receiver (200) that is capable of receiving a downstream optical signal and selecting a corresponding coherent wavelength from the downstream optical signal. In some embodiments, the tunable coherent receiver (200) is a colorless coherent receiver. The tunable coherent receiver (200) includes at least a local oscillator (202) and a digital signal processor (DSP) (204). In other embodiments, the tunable coherent receiver (200) can include more or less components (e.g., amplifiers, converters, photodiodes, etc.).

The local oscillator (202) and the DSP (204) are configured to detect or filter a target wavelength from a split signal received from, for example, the splitter (118). More specifically, the split signal includes n-number of coherent wavelengths λₙ (206) such as wavelengths λ₁ (206)(1), λ₂ (206)(2), λₙ (206)(n) as shown in FIG. 2B. The local oscillator (202) and the DSP (204) can be tuned or programmed to detect a target wavelength such as wavelength λₜ (208), shown in FIG. 2C. More specifically, the local oscillator (202) and DSP (204) select the wavelength λₜ (210) from the n-number of coherent wavelengths λₙ (206)(n).

Thus, the tunable coherent receiver (200) enables each CPON ONU (108) to be tuned to the coherent wavelength at which corresponding CPON OLTs (106) transmit a CPON downstream optical signal. Such ability enables signals of multiple different wavelengths to be stacked on the OLT side and received at the ONUs without the use of optical filters or colored filters such as the filters (114). Thus, component and operational costs can be reduced with the use of tunable coherent receivers (200) at the CPON ONUs (108).

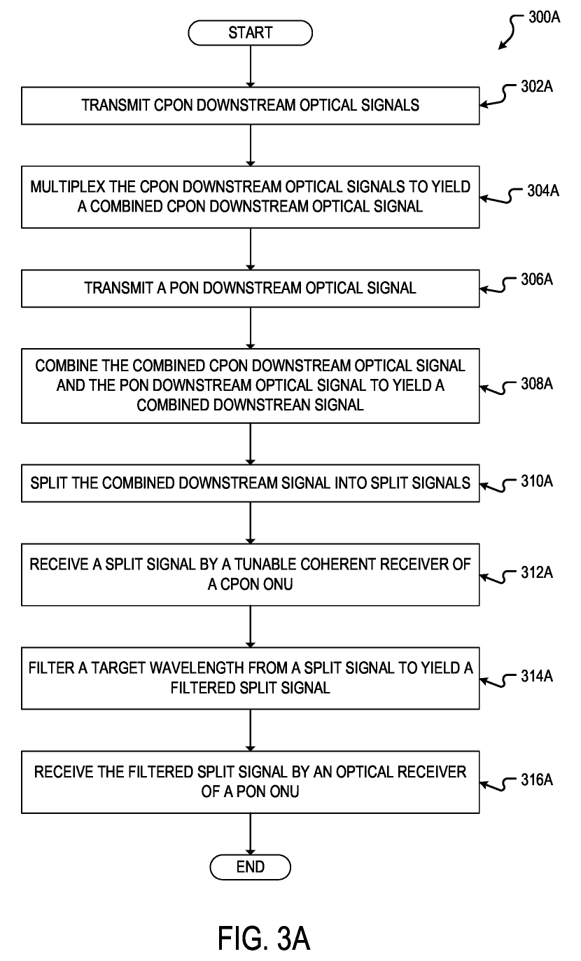

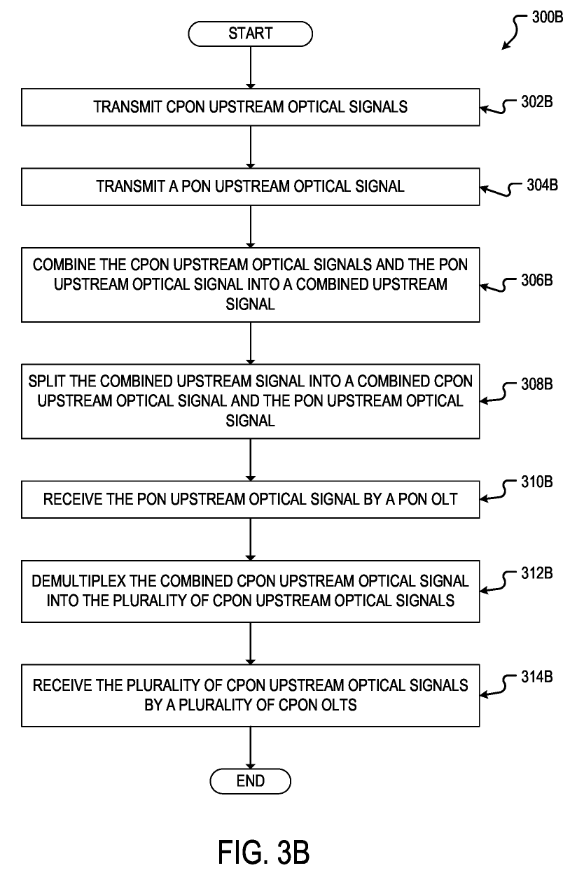

FIG. 3A is a flowchart of a method (300A) according to at least one embodiment of the present disclosure. The method (300A) are steps or operations that the ODN (100) executes to transmit data downstream via a CPON such as the CPON (102) and a PON such as the PON (104).

Step 302A of the method (300A) provides for transmitting CPON downstream optical signals. Each CPON downstream optical signal is generated by a CPON OLT, such as the CPON OLT (106), of a plurality of CPON OLTs. Each CPON downstream optical signal is transmitted at a corresponding downstream coherent wavelength of a plurality of downstream coherent wavelengths. The CPON downstream optical signals are transmitted via an optical communication medium such as the optical communication medium (120).

Step 304A of the method (300A) provides for multiplexing the CPON downstream optical signals to yield a combined CPON downstream optical signal. The CPON downstream optical signals may be multiplexed by a MUX such as the MUX (122).

Step 306A of the method (300A) provides for transmitting a PON downstream optical signal. The PON downstream optical signal is generated by a PON OLT such as the PON OLT (110) and transmitted via the optical communication medium.

Step 308A of the method (300A) provides for combining the combined CPON downstream optical signal and the PON downstream optical signal to yield a combined downstream signal. The combined CPON downstream optical signal and the PON downstream optical signal may be combined by a CEx, such as the CEx (116) to yield the combined downstream signal.

Step 310A of the method (300A) provides for splitting the combined downstream signal into split signals. The combined downstream signal is split by a splitter such as the splitter (118) into multiple split signals. Each split signal may be equal split signals.

Step 312A of the method (300A) provides for receiving a split signal by a tunable coherent receiver of a CPON ONU. The tunable coherent receiver may be the same as or similar to the tunable coherent receiver (200) and the CPON ONU may be the same as or similar to the CPON ONU (108). The tunable coherent receiver is tuned to the corresponding downstream coherent wavelength of the corresponding CPON OLT such that the tunable coherent receiver can select or filter the corresponding downstream coherent wavelength from multiple wavelengths.

Step 314A of the method (300A) provides for filtering a target wavelength from a split signal to yield a filtered split signal. The target wavelength may be filtered by a filter such as the filter (114).

Step 316A of the method (300A) provides for receiving the filtered split signal by an optical receiver of a PON ONU. The PON ONU may be the same as or similar to the PON ONU (112).

The method (300A) described in FIG. 3A can include more or less steps. One or more steps or any combination of steps may also be repeated in the method described in FIG. 3A.

FIG. 3B is a flowchart of a method (300B) according to at least one embodiment of the present disclosure. The method (300B) are steps or operations that the ODN (100) executes to transmit data upstream via a CPON such as the CPON (102) and a PON such as the PON (104).

Step 302B of the method (300B) provides for transmitting CPON upstream optical signals. Each CPON upstream optical signal is generated by an ONU transmitter such as the ONU transmitter (212) of a CPON ONU such as the CPON ONU (108). Each CPON upstream optical signal is transmitted at a corresponding upstream coherent wavelength of a plurality of upstream coherent wavelengths. The CPON downstream optical signals are transmitted via an optical communication medium such as the optical communication medium (120).

Step 304B of the method (300B) provides for transmitting a PON upstream optical signal. The PON upstream optical signal is generated by the PON ONU transmitter of a PON ONU such as the PON ONU (112) and transmitted via the optical communication medium.

Step 306B of the method (300B) provides for combining the PON upstream optical signal and the CPON upstream optical signals to yield a combined upstream signal. The PON upstream optical signal and the CPON upstream optical signals may be combined by a CEx, such as the CEx (116) to yield the combined upstream signal.

Step 308B of the method (300B) provides for splitting the combined upstream signal into the PON upstream optical signal and a combined CPON upstream optical signal. The combined upstream signal is split by a splitter such as the splitter (118).

Step 310B of the method (300B) provides for receiving the PON upstream optical signal by an optical receiver of a PON OLT such as the PON OLT (110).

Step 312B of the method (300B) provides for demultiplexing the combined CPON upstream optical signal into separate CPON upstream optical signals. The combined CPON upstream signal may be multiplexed by a MUX such as the MUX (122).

Step 314B of the method (300B) provides for receiving the CPON upstream optical signals by corresponding CPON OLTs such as the CPON OLTs (106). The CPON OLT may include a tunable receiver to receive the corresponding CPON upstream optical signal at the corresponding upstream coherent wavelength.

The method (300B) described in FIG. 3B can include more or less steps. One or more steps or any combination of steps may also be repeated in the method described in FIG. 3B.

### III. Experimental Demonstrations

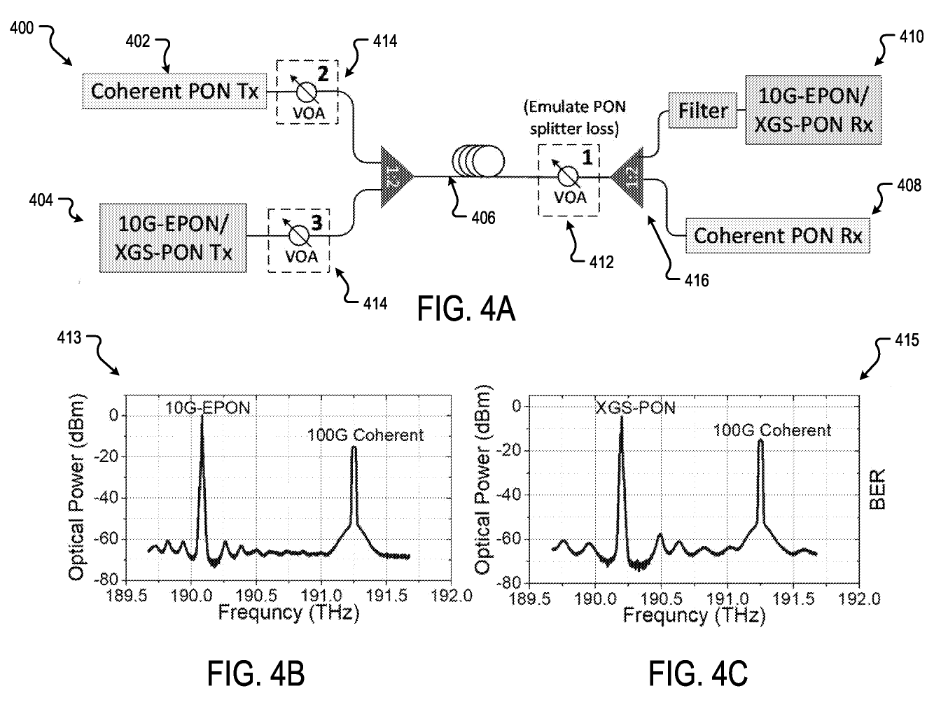

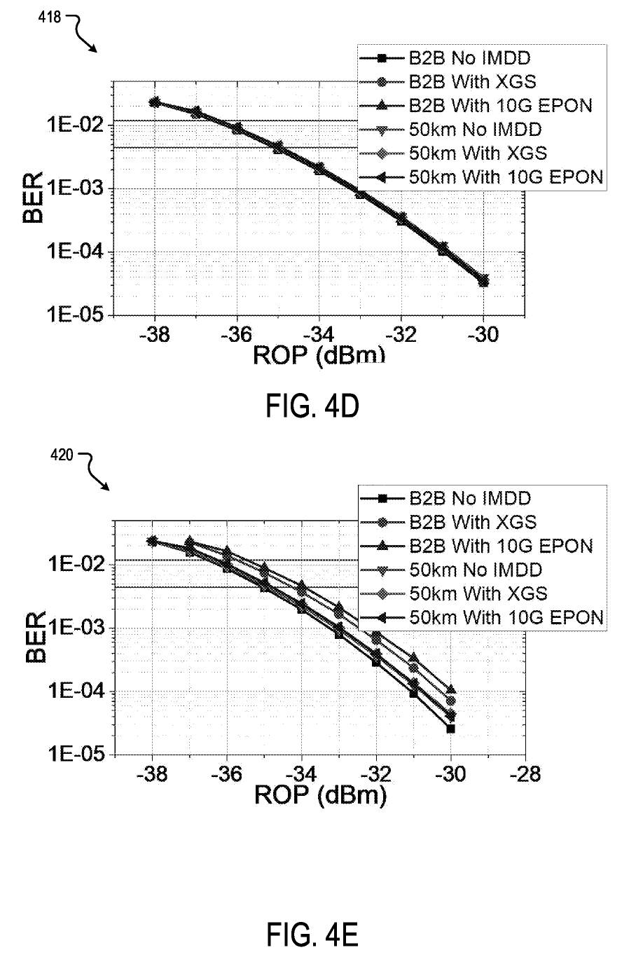

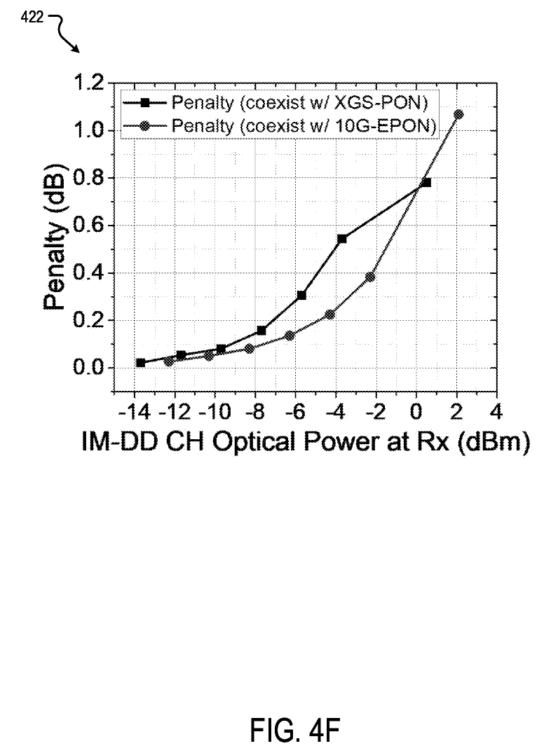

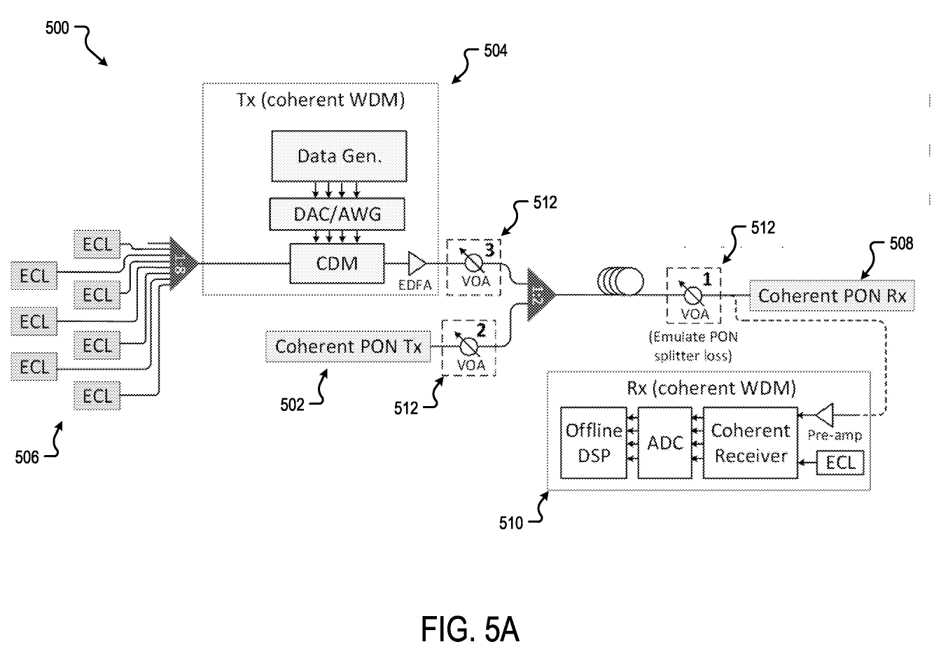

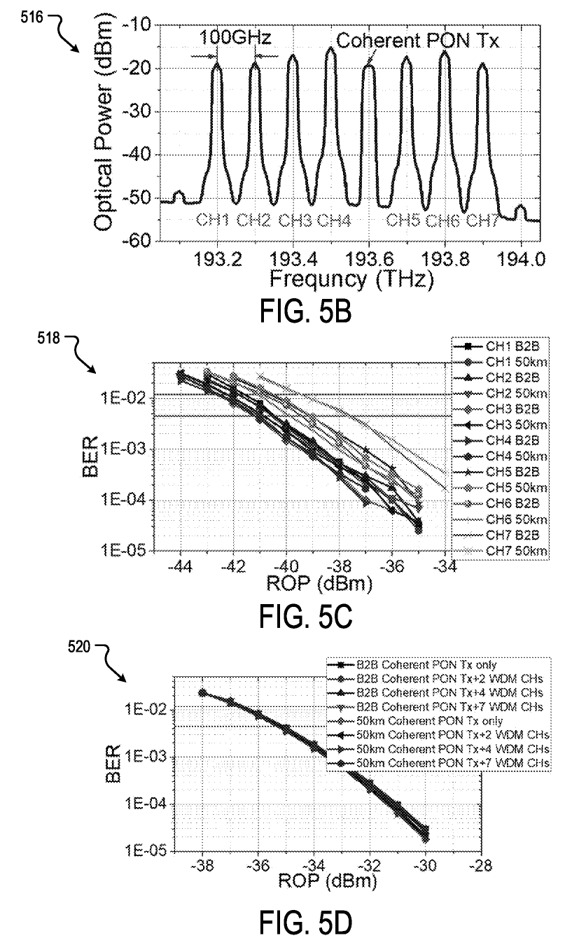

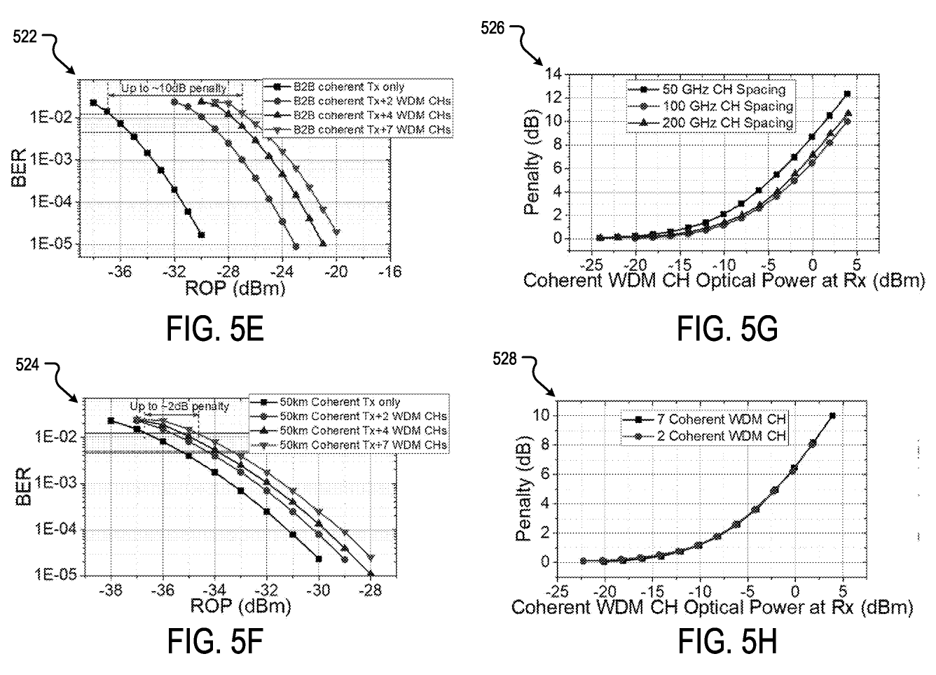

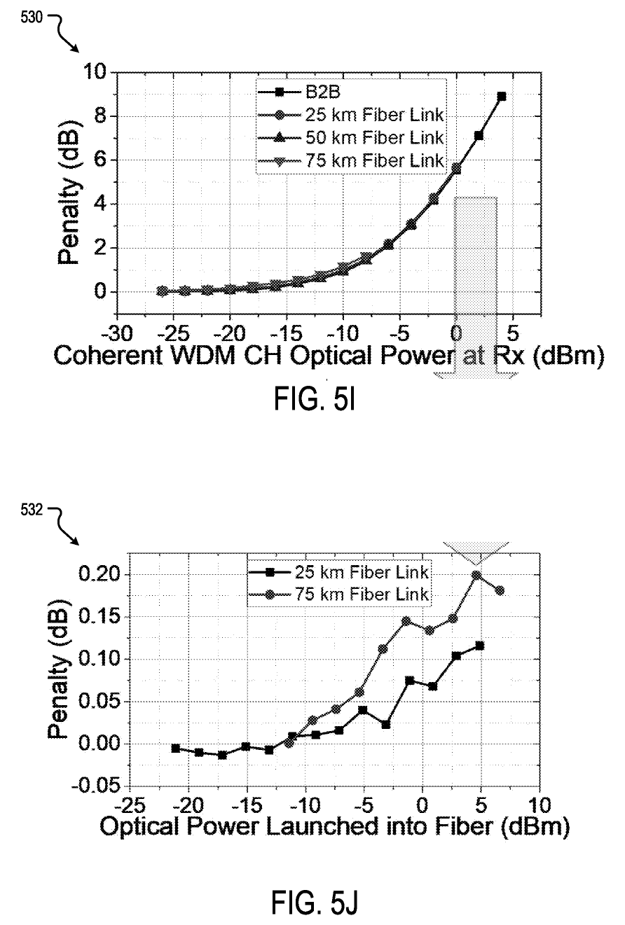

To demonstrate utility of the above embodiments, a first experimental setup and results described in FIGS. 4A-4F and a second experimental setup and results described in FIGS. 5A-5J were configured to demonstrate real-world implementations of the optical distribution ODN (100) with coexisting CPON (102) and PON (104) of FIG. 1. The experimental results verify the capability of the ODN to effectively accommodate the coexistence of IM-DD and multiple coherent PON wavelengths.

Turning to FIG. 4A, a schematic illustration of an example test architecture (400) for verifying experimental results implementing the ODN with coexisting CPON and PON embodiments are provided. More particularly, the test architecture (400) implemented a real-world operation of an ODN with coexisting CPON and PON embodiments and included a 100G colorless coherent PON with a 10G IM-DD PON through a number of dedicated optical fiber segments (406). The test architecture (400) included a commercial coherent module such as the 100 Gb/s coherent PON transmitter (402) and the colorless coherent receiver (408) and either a 10G-EPON or XGS-PON transmitter (404) and receiver (410) simulated the IM-DD PON. The optical distribution network also comprised a 1x2 optical splitter (416) and up to 50 km of fiber. A low split ratio was used to maximize the IM-DD signal power at the colorless coherent receiver (408) to enable performance impact assessment. Variable optical attenuators (VOAs) (414) were also used to adjust power levels and emulate attenuation from passive splitter (VOA1) (412), and different test configurations were evaluated.

FIGS. 4B and 4C are graphical illustrations depicting a plot (413) and another plot (415), respectively, obtained using the test architecture (400) of FIG. 4A. More particularly, the plot (413) and the plot (415) illustrate the optical spectra for the coexistence of CPON with 10G-EPON and XGS-PON, respectively.

FIG. 4D is a graphical illustration depicting a plot (418) obtained using the test architecture (400) of FIG. 4A. The plot (418) illustrates a bit-error-rate (BER) versus received optical power (ROP) of the colorless coherent receiver (408) in the presence of 10G-EPON or XGS-PON signals within the same ODN. A VOA (412) at Spot 1 provides equal attenuation to both signals and also emulates attenuation from passive splitter. The BER results shown for both back-to-back (B2B) and 50 km fiber transmission demonstrate that at low power levels (around -30 dBm or lower), the IM-DD signals have negligible impact on the coherent reception at the colorless coherent receiver (408).

FIG. 4E is a graphical illustration depicting a plot (420) obtained using the test architecture (400) of FIG. 4A. The plot (420) illustrates a BER versus ROP of the colorless coherent receiver (408) in the presence of 10G-EPON or XGS-PON signals within the same ODN. A VOA (414) at Spot 2 attenuated only the coherent signal and allowed the IM-DD signals to reach the colorless coherent receiver (408) at full power. This results in a 1 dB penalty under B2B conditions, which disappears over 50 km fiber transmission, which suggests that the performance degradation depends on the power of unwanted noise signals and are mitigated by fiber attenuation over distance.

FIG. 4F is a graphical illustration depicting a plot (422) obtained using the test architecture (400) of FIG. 4A. More particularly, the plot (422) illustrates multiple BER curves that were recorded under varying IM-DD signal power levels and with performance penalties extracted at a 1.2E-2 soft decision (SD) forward error correction (FEC) threshold. Two VOAs (414) at Spot 2 and Spot 3 were attenuating both IM-DD and coherent signals. The results indicated a 1 dB penalty at maximum IM-DD power, which decreased rapidly with reduced power. Thus, the IM-DD signal’s impact on the colorless coherent receiver (408) is negligible, demonstrating its robustness in real-world deployments.

Turning to FIGS. 5A-5J, a second experimental setup and results will now be described. FIG. 5A is a schematic illustration of another example test architecture (500) for verifying experimental results implementing the ODN with coexisting CPON and PON as described herein. The test architecture (500) included a coherent PON transmitter (502) alongside a transmitter (504) producing seven 100G coherent channels generated by a 92-GSa/s arbitrary waveform generator (AWG), seven external cavity lasers (ECLs) (506), and a 64 GBaud coherent driver modulator (CDM) producing 25 GBd DP-QPSK signals. The transmitter (504) included an erbium-doped fiber amplifier (EDFA) that adjusted each channel’s optical power to approximately 0 dBm. The transmitted signal was detected by a colorless coherent receiver (508), and the remaining seven coherent channels were analyzed using an integrated coherent receiver (ICR) (510) with an LO. The recorded signals were processed offline. The test architecture (500) also included VOAs (512) that were placed at various locations for different test scenarios.

FIG. 5B is a graphical illustration depicting a plot (516) obtained using the test architecture (500) of FIG. 5A. More particularly, the plot (516) illustrates the optical spectrum of the coherent WDM channels with 100 GHz channel spacing.

FIG. 5C is a graphical illustration depicting a plot (518) obtained using the test architecture (500) of FIG. 5A. More particularly, the plot (518) illustrates a BER performance as a function of average ROP per WDM channel for the seven coherent WDM channels, evaluated in both B2B and 50 km transmission scenarios. Variations in the BER reflect slight optical power differences across the WDM channels due to the single CDM.

FIG. 5D is a graphical illustration depicting a plot (520) obtained using the test architecture (500) of FIG. 5A. More particularly, the plot (520) illustrates a BER vs. ROP results for the colorless coherent receiver (508), with and without the presence of the seven coherent channels, using a VOA (512) at Spot 1 to ensure equal attenuation to all signals. When operating at low optical power levels (around -30 dBm or lower), the impact of neighboring coherent channels on signal reception is negligible, which demonstrates the colorless coherent receiver’s (508) ability to handle multiple coherent WDM channels under realistic power conditions.

FIGS. 5E and 5F are graphical illustrations depicting a plot (522) and a plot (524), respectively, obtained using the test architecture (500) of FIG. 5A. More particularly, the plot (522) illustrates a BER versus ROP results for different numbers of the coherent WDM channels B2B and the plot (524) illustrates a BER versus ROP results for different numbers of the coherent WDM channels after a 50km fiber transmission. A VOA (512) at Spot 2 attenuated only the detected coherent signal, allowing the other WDM channels to reach the colorless coherent receiver (508) at near-full power. The results reveal a significant 10 dB penalty in B2B transmission with the presence of 7 coherent WDM channels, as shown in plot (522), but only a 2 dB penalty after 50 km fiber transmission, as shown in plot (524). Such results suggest that increased fiber distance attenuated noise from unwanted WDM channels and reduced performance degradation.

FIG. 5G is a graphical illustration depicting a plot (526) obtained using the test architecture (500) of FIG. 5A. More particularly, the plot (526) illustrates a penalty (dB) versus coherent WD CH optical power at the receiver (dBm). The performance penalty, extracted at the 1.2E-2 SD-FEC threshold, decreased rapidly as the WDM channel power reduced and denser 50 GHz channel spacing induced higher penalties than 100 GHz and 200 GHz.

FIG. 5H is a graphical illustration depicting a plot (528) obtained using the test architecture (500) of FIG. 5A. More particularly, the plot (528) illustrates a penalty (dB) versus coherent WD CH optical power at the receiver (dBm). The plot (528) indicated that the number of additional WDM channels (2 vs. 7) had a negligible impact on the performance penalty for a given received optical power.

FIG. 5I is a graphical illustration depicting a plot (530) obtained using the test architecture (500) of FIG. 5A. More particularly, the plot (530) illustrates a penalty (dB) versus coherent WD CH optical power at the receiver (dBm). The plot (520) showed minimal performance penalty difference across varying transmission distances (B2B, 25 km, 50 km, 75 km).

FIG. 5J is a graphical illustration depicting a plot (532) obtained using the test architecture (500) of FIG. 5A. More particularly, the plot (532) illustrates a penalty (dB) versus optical power launched into fiber (dBm). The plot (532) indicated that penalties from fiber nonlinearity and impairments are insignificant compared to those from excess WDM channel power. Thus, in practical PON scenarios with, e.g., 20 dB link loss, the adjacent WDM channels cause a performance penalty of 0.5 dB, confirming the robustness of the colorless coherent receiver (508) in realistic deployments.

As described herein, ODNs in which CPON and PON coexist provide for the stacking of multiple CPON wavelengths alongside legacy PON systems using IM-DD and/or WDM. Such stacking is enabled by using tunable coherent receivers such as, for example, colorless coherent receivers that enable wavelength selection at the ONUs. Such colorless coherent receivers eliminate the need for optical filters, unlike legacy IM-DD PONs, which require specific wavelength filters (“colored” optics).

Exemplary embodiments for ODNs with coexisting CPON and PON are described above in detail. The systems and methods of this disclosure though, are not limited to only the specific embodiments described herein, but rather, the components and/or steps of their implementation may be utilized independently and separately from other components and/or steps described herein. Additionally, the exemplary embodiments can be implemented and utilized in connection with other access networks utilizing fiber and coaxial transmission at the end user stage.

The foregoing discussion has been presented for purposes of illustration and description. The foregoing is not intended to limit the disclosure to the form or forms disclosed herein. In the foregoing detailed description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this detailed description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, i.e., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An optical distribution network comprising:
a passive optical network (PON) optical line terminal (OLT) configured to transmit a PON downstream optical signal to a PON optical network unit (ONU) disposed remotely from the PON OLT and to receive a PON upstream optical signal from the PON ONU;
a coherent passive optical network (CPON) OLT configured to transmit a CPON downstream optical signal to a CPON ONU disposed remotely from the CPON OLT and to receive a CPON upstream optical signal from the CPON ONU;
an optical communication medium in operable communication with the PON OLT and the CPON OLT, and configured to transport the PON downstream optical signal to the PON ONU and the PON upstream optical signal to the PON OLT, and to transport the CPON downstream optical signal to the CPON ONU and the CPON upstream optical signal to the CPON OLT;
the PON ONU in operable communication with the optical communication medium and including an optical receiver configured to receive the PON downstream optical signal and a PON optical transmitter configured to transmit the PON upstream optical signal; and
the CPON ONU in operable communication with the optical communication medium and including a tunable coherent receiver configured to receive the CPON downstream optical signal and a CPON optical transmitter configured to transmit the CPON upstream optical signal.

2. The optical distribution network of claim 1, wherein the CPON OLT comprises a plurality of CPON OLTs and each CPON OLT is configured to transmit a corresponding CPON downstream optical signal of a plurality of CPON downstream optical signals and to receive a corresponding CPON upstream optical signal of a plurality of CPON upstream optical signals, each CPON downstream optical signal transmitted at a corresponding downstream coherent wavelength and each CPON upstream optical signal transmitted at a corresponding upstream coherent wavelength, and wherein the CPON ONU comprises a plurality of corresponding CPON ONUs and each tunable coherent receiver is tuned to the first corresponding coherent wavelength, and wherein each CPON OLT is tuned to the second corresponding coherent wavelength.

3. The optical distribution network of claim 2, wherein a first downstream coherent wavelength of a first CPON downstream optical signal is different than a second downstream coherent wavelength of a second CPON downstream optical signal, and wherein a first upstream coherent wavelength of a first CPON upstream optical signal is different than a second upstream coherent wavelength of a second CPON upstream optical signal.

4. The optical distribution network of claim 2, further comprising:
a multiplexer configured to multiplex the plurality of CPON downstream optical signals to yield a combined CPON downstream optical signal and to demultiplex a combined CPON upstream optical signal into the plurality of CPON upstream optical signals.

5. The optical distribution network of claim 1, wherein the PON OLT and PON ONU use at least one of intensity modulation with direct detection (IM-DD), wavelength-division-multiplexing (WDM), or a combination of IM-DD and WDM.

6. The optical distribution network of claim 4, further comprising:
a coexistence element (CEx) in communication with the PON OLT and the CPON OLT, the CEx configured to combine the PON downstream optical signal and the combined CPON downstream optical signal into a combined downstream signal for transmission through the optical communication medium, the CEx configured to also split a combined upstream signal into the PON upstream optical signal and the combined CPON upstream optical signal; and
at least one splitter in communication with the CEx, the PON ONU, and the CPON ONU, the at least one splitter configured to split the combined signal into a plurality of split signals for transmission to the PON ONU and the CPON ONU.

7. The optical distribution network of claim 6, wherein the plurality of split signals are equal signals.

8. The optical distribution network of claim 6, further comprising:
an optical filter in communication with the splitter, the PON ONU, and the optical communication medium, the optical filter configured to filter a target wavelength from a split signal of the plurality of split signals received from the splitter to yield a filtered split signal.

9. The optical distribution network of claim 6, wherein the tunable coherent receiver comprises a colorless coherent optical receiver that comprises a local oscillator and digital signal processing (DSP), and wherein the local oscillator and the DSP are tuned to select a target wavelength from a split signal of the plurality of split signals received from the splitter.

10. The optical distribution network of claim 1, wherein the tunable coherent receiver comprises a colorless coherent optical receiver.

11. A method comprising:
transmitting a plurality of CPON downstream optical signals via an optical communication medium, each CPON downstream optical signal generated by a CPON OLT of a plurality of CPON OLTs, each CPON downstream optical signal transmitted at a corresponding downstream coherent wavelength;
multiplexing, by a multiplexer (MUX), the plurality of CPON downstream optical signals to yield a multiplexed CPON downstream optical signal;
transmitting, by a PON OLT, a PON downstream optical signal via the optical communication medium, the PON downstream optical signal generated by the PON OLT;
combining, by a coexistence element (CEx), the PON downstream optical signal and the multiplexed CPON downstream optical signal to yield a combined signal;
splitting, by at least one splitter, the combined signal into a plurality of split signals;
receiving, by a tunable downstream coherent receiver, a split signal of the plurality of split signals, the tunable downstream coherent receiver part of a CPON ONU of a plurality of CPON ONUs and tuned to the corresponding downstream coherent wavelength; and
receiving, by an optical receiver, a split signal of the plurality of split signals, the optical receiver part of a PON ONU.

12. The method of claim 11, further comprising:
transmitting a plurality of CPON upstream optical signals via the optical communication medium, each CPON upstream optical signal generated by a corresponding CPON ONU of the plurality of CPON ONUs and transmitted at a corresponding upstream coherent wavelength;
transmitting, by the PON ONU, a PON upstream optical signal via the optical communication medium;
combining, by the at least one splitter, the plurality of CPON upstream optical signals and the PON upstream optical signal into an upstream combined signal;
splitting, by the CEx, the combined signal into a combined CPON upstream optical signal and the PON upstream optical signal;
receiving, by the PON OLT, the PON upstream optical signal;
demultiplexing, by the MUX, the combined CPON upstream optical signal to yield the plurality of upstream optical signals; and
receiving the plurality of upstream optical signals by the plurality of CPON OLTs, each CPON OLT having a tunable upstream coherent receiver tuned to the corresponding upstream coherent wavelength.

13. The method of claim 11, wherein a first downstream coherent wavelength of a first CPON downstream optical signal is different than a second downstream coherent wavelength of a second CPON downstream optical signal, and wherein a first upstream coherent wavelength of a first CPON upstream optical signal is different than a second upstream coherent wavelength of a second CPON upstream optical signal.

14. The method of claim 11, wherein the PON OLT and PON ONU use at least one of intensity modulation with direct detection (IM-DD), wavelength-division-multiplexing (WDM), or a combination of IM-DD and WDM.

15. The method of claim 11, further comprising:
filtering, by an optical filter, a target wavelength from a split signal of the plurality of split signals to yield a filtered split signal, the optical filter in communication with the at least one splitter, the PON ONU, and the optical communication medium.

16. The method of claim 11, wherein the tunable coherent receiver comprises a colorless coherent optical receiver that comprises a local oscillator and digital signal processing (DSP), and wherein the local oscillator and the DSP are tuned to select a target wavelength from a split signal of the plurality of split signals received from the splitter.

17. An optical distribution network comprising:
a passive optical network (PON) optical line terminal (OLT) configured to transmit a PON downstream optical signal to a PON optical network unit (ONU) disposed remotely from the PON OLT and to receive a PON upstream optical signal from the PON ONU;
a plurality of coherent passive optical network (CPON) OLTs, each CPON OLT configured to transmit a CPON downstream optical signal of a plurality of CPON downstream optical signals to a corresponding CPON ONU of a plurality of CPON ONUs disposed remotely from the plurality of CPON OLTs and to receive a CPON upstream optical signal of a plurality of CPON upstream optical signals from a corresponding CPON ONU, each CPON downstream optical signal transmitted at a corresponding downstream coherent wavelength and each CPON upstream optical signal transmitted at a corresponding upstream coherent wavelength;
a multiplexer configured to multiplex the plurality of CPON downstream optical signals to yield a combined CPON downstream optical signal and to demultiplex a combined CPON upstream optical signal into a plurality of CPON upstream optical signals;
a coexistence element (CEx) in communication with the PON OLT and the multiplexer, the CEx configured to combine the PON downstream optical signal and the combined CPON downstream optical signal into a combined downstream signal and to separate a combined upstream signal into the combined CPON upstream optical signal and the PON upstream signal;
at least one splitter in communication with the CEx, the PON ONU, the CPON ONU, the splitter configured to split the combined downstream signal into a plurality of split signals for transmission to the PON ONU and the plurality of CPON ONUs and to combine the PON upstream optical signal and the plurality of upstream optical signals into a combined upstream signal; and
an optical communication medium in operable communication with the PON, the plurality of CPONs, the PON ONU, the plurality of CPON ONUs, the CEx, and the splitter, the optical communication medium configured to transport the PON downstream optical signal to the PON ONU and the PON upstream optical signal to the PON OLT, and to transport the plurality of CPON downstream optical signals to the plurality of CPON ONUs and the plurality of CPON upstream optical signals to the plurality of CPON OLTs;
the PON ONU in operable communication with the optical communication medium and the splitter, the PON ONU including an optical receiver configured to receive a split signal of the plurality of split signals and a PON optical transmitter configured to transmit the PON upstream optical signal; and
each CPON ONU of the plurality of CPON ONUs in operable communication with the optical communication medium and the splitter, each CPON ONU including a tunable coherent receiver configured to receive a split signal of the plurality of split signals and a CPON optical transmitter configured to transmit a corresponding CPON upstream optical signal, the tunable coherent receiver tuned to the corresponding coherent wavelength.

18. The optical distribution network of claim 17, further comprising:
an optical filter in communication with the at least one splitter, the PON ONU, and the optical communication medium, the optical filter configured to filter a target wavelength from the split signal of the plurality of split signals received from the splitter to yield a filtered split signal.

19. The optical distribution network of claim 17, wherein the tunable coherent receiver comprises a colorless coherent optical receiver that comprises a local oscillator and digital signal processing (DSP), and wherein the local oscillator and the DSP are tuned to select a target wavelength from the split signal of the plurality of split signals received from the splitter.

20. The optical distribution network of claim 17, wherein the PON uses at least one of intensity modulation with direct detection (IM-DD), wavelength-division-multiplexing (WDM), or a combination of IM-DD and WDM.
